(19) United States
(12) Patent Application Publication
(10) Pub. No.: US 2013/0281134 A1
(43) Pub. Date: Oct. 24, 2013

(54) METHOD AND DEVICE FOR SENDING AND RECEIVING IDLE MODE RETAIN INFORMATION ABOUT A PAGING-MESSAGE FALSE ALARM IN A WIRELESS COMMUNICATION SYSTEM

(71) Applicants: Giwon Park, Anyang-si (KR); Youngsoo Yuk, Anyang-si (KR)

(72) Inventors: Giwon Park, Anyang-si (KR); Youngsoo Yuk, Anyang-si (KR)

(73) Assignee: LG ELECTRONICS INC., Seoul (KR)

(21) Appl. No.: 13/977,801

(22) PCT Filed: Jan. 4, 2012
(86) PCT No.: PCT/KR12/00085

§ 371 Date: Jul. 9, 2013

Related U.S. Application Data
(60) Provisional application No. 61/430,546, filed on Jan. 7, 2011.

(51) Int. Cl. H04W 68/02

(52) U.S. Cl. CPC H04W 68/02
USPC 455/458

(57) ABSTRACT

The method for receiving idle mode retain information of the present invention is a method entailing: receiving a paging message from a base station; transmitting a ranging request message to the base station; and receiving a ranging response message comprising an idle mode retain parameter relating to terminal idle-mode retention from the base station as a response to the ranging request message.

### TECHNICAL FIELD

The present invention relates to a wireless communication system, and more particularly, to a method of transmitting and receiving a ranging response message to restore an error for a false alarm of a paging message and apparatus therefor.

### BACKGROUND ART

The present invention relates to a wireless communication network, and more particularly, to a method of transmitting and receiving a ranging response message in a wireless network and a method of transmitting and receiving a remaining idle mode information using the ranging response message.

A plurality of paging controllers manages one identical paging group in a network of a wireless communication system. In this case, user equipments belong to the one paging group may have an identical deregistration identifier (DID), an identical paging cycle, and an identical paging offset. In this case, a plurality of the paging controllers may be able to page the user equipments having an identical DID, which are belong to the one paging group. Yet, in case of a user equipment not intended to be paged, the user equipment should stay in an idle mode. However, the user equipment performs a network re-entering process.

An idle mode of a user equipment corresponds to a state that the user equipment or a network cancels a radio link in case that a radio link, which is currently serviced by the user equipment, is cancelled by an abnormal reason or the user equipment does not have data to be transmitted or received. The idle mode corresponds to a function enabling the user equipment to promptly perform a network re-entry procedure, which may occur later, in a manner that the network stores registration information and authentication information of the user equipment for a prescribed time period.

A mobile user equipment supports an idle mode to reduce power consumption and the mobile user equipment needs a network structure and procedure to control a paging in the idle mode. Yet, a parameter for excluding a network re-entry process between a user equipment and a base station is not currently defined by 3GPP (3^{rd} generation partnership project) LTE (long term evolution) technical field as well as IEEE 802.16m standard.

### DISCLOSURE OF THE INVENTION

### Technical Tasks

A technical task that the present invention intends to achieve is to provide a method of excluding a network re-entry process in case that a user equipment included in one paging group receives a false paging message because a plurality of paging controllers manage the one identical paging group.

A different technical task that the present invention intends to achieve is to provide a user equipment device in case that a user equipment included in one paging group receives a false paging message because a plurality of paging controllers manage the one identical paging group.

A different technical task that the present invention intends to achieve is to provide a method of excluding a network re-entry process in case that a plurality of paging controllers transmit a false paging message to a user equipment included in one paging group because a plurality of the paging controllers manage the one identical paging group.

A further different technical task that the present invention intends to achieve is to provide a base station device in case that a plurality of paging controllers transmit a false paging message to a user equipment included in one paging group because a plurality of the paging controllers manage the one identical paging group.

### Technical Solution

To achieve the technical task and in accordance with the present invention, as embodied and broadly described, a method for receiving information of remaining idle mode, which is received by a user equipment in a wireless communication system includes the steps of receiving a paging message from a base station, transmitting a ranging request message to the base station, receiving a ranging response message containing a remain idle mode parameter related to remaining the idle mode of the UE from the base station in response to the ranging request message.

To achieve the different technical task and in accordance with the present invention, as embodied and broadly described, a User Equipment (UE) configured to receive information of remaining idle mode in a wireless communication system includes a Radio Frequency (RF) unit configured to transmit and receive wireless signals and a processor configured to control the RF unit in a manner of being connected to the RF unit, wherein the processor is configured to control the RF unit to receive a paging message from a base station, configured to control the RF unit to transmit a ranging request message to the base station, and configured to control the RF unit to receive a ranging response message containing a remain idle mode parameter related to remaining the idle mode of the UE from the base station in response to the ranging request message.

To achieve the different technical task and in accordance with the present invention, as embodied and broadly described, a method for transmitting information of remaining idle mode, which is transmitted by a base station in a wireless communication system includes the steps of transmitting a paging message to a User Equipment (UE), receiving a ranging request message from the UE, obtaining information on whether the paging message is a false alarm message from an authenticator, and transmitting a ranging response message containing a remain idle mode parameter related to remaining the idle mode to the UE.

To achieve the further different technical task and in accordance with the present invention, as embodied and broadly described, a base station configured to transmit information of remaining idle mode in a wireless communication system includes a Radio Frequency (RF) unit configured to transmit and receive wireless signals and a processor configured to control the RF unit in a manner of being connected to the RF unit, wherein the processor is configured to control the RF unit to transmit a paging message to a UE (User Equipment), configured to control the RF unit to receive a ranging request message from the UE, configured to obtain information on whether the paging message is a false alarm message from an authenticator, and configured to control the RF unit to transmit a ranging response message containing a remain idle mode parameter related to remaining the idle mode to the UE.

In order to achieve the aforementioned task, according to one embodiment of the present invention, if the remain idle mode parameter indicates the UE to remain the idle mode, the UE remains the idle mode as it is.

In order to achieve the aforementioned task, according to a different embodiment of the present invention, the remain idle mode parameter corresponds to an indicator remaining the idle mode of the UE.

### Advantageous Effects

Accordingly, the present invention may be able to exclude a network re-entry process resulted from a false alarm of a paging message, which may occur in case that a plurality of paging controllers control user equipments to which an identical DID (deregistration identifier), an identical paging cycle, and an identical paging offset are assigned.

According to the present invention, it is able to reduce an overhead in a manner of maintaining an idle mode without terminating the idle mode. Hence, communication quality can be enhanced and a reliable communication is available.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a base station and a user equipment;

FIG. 2 is a diagram of a network entry procedure of a user equipment;

FIG. 3 is a diagram of a network entry procedure of a user equipment;

FIG. 4 is a diagram of a network entry procedure of a user equipment according to one embodiment of the present invention.

### BEST MODE

### Mode for Invention

Reference will now be made in detail to the preferred embodiments of the present invention, examples of which are illustrated in the accompanying drawings. Detail explanation disclosed in the following description with reference to the attached drawings intends not to explain a unique embodiment implementable by the present invention but to explain an exemplary embodiment of the present invention. In the following detailed description of the invention includes details to help the full understanding of the present invention. Yet, it is apparent to those skilled in the art that the present invention can be implemented without these details.

Occasionally, to prevent the present invention from getting vaguer, structures and/or devices known to the public are skipped or can be represented as block diagrams centering on the core functions of the structures and/or devices. Wherever possible, the same reference numbers will be used throughout the drawings to refer to the same parts.

The following technology may apply to such a various multiple access scheme as CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3rd Generation Partnership Project) LTE (long term evolution) is a part of E-UMTS (Evolved UMTS) that uses E-UTRA. 3GPP LTE adopts OFDMA in downlink and adopts SC-FDMA in uplink. LTE-A (LTE-Advanced) is an evolved version of 3GPP LTE.

In the present invention, WCDMA network, CDMA network, or the like except LTE network is explained as a legacy network with an example. Besides, assume that a terminal is a common name for such a mobile or fixed user side device as a UE (user equipment), an MS (mobile station), an AMS (advanced mobile station), an M2M (machine to machine) device and the like. And, assume that a base station is a common name for such a random node of a network side communicating with a terminal as a Node B, an eNode B, a base station, an ANB (advanced base station), an AP (access point), and the like. Although the present invention is explained based on IEEE 802.16m, contents of the present invention can be applicable to such a different communication system as 3GPP LTE and LTE-A system.

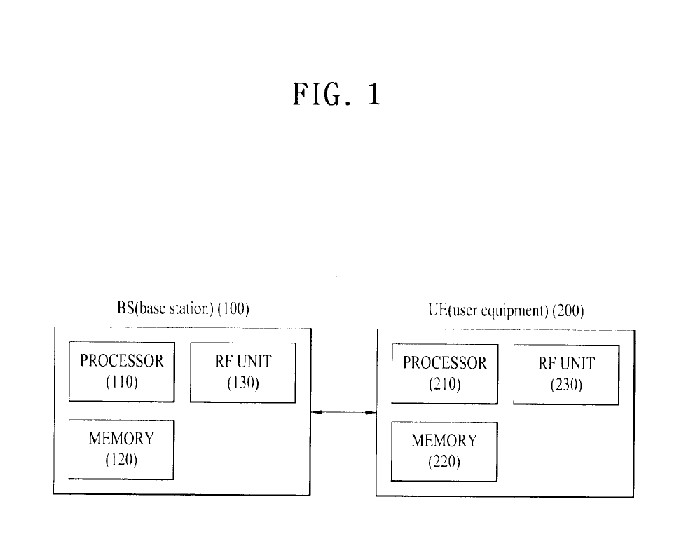

FIG. 1 is a block diagram of a base station and a user equipment.

A base station 100 includes a processor 110, a memory 120, and a RF (radio frequency) unit 130. The processor 110 implements a function, a process and/or a method proposed according to embodiment of the present invention. For instance, the processor 110 may be able to obtain information on whether a paging message corresponds to a false alarm from an authenticator. Or, the processor 110 may be able to indicate a user equipment 200 to maintain an idle mode by a parameter for maintaining an idle mode. The memory 120 is connected to the processor 110 and then stores various informations necessary for operating the processor 110. The RF unit 130 is connected to the processor 110 and then transmits and/or receives a radio signal under a control of the processor 110. The RF unit 130 can be configured with a plurality of nodes connected to the base station 100 in wired. The processor 110 may be able to control that the RF unit 130 is configured to transmit a paging message to the user equipment 100, configured to receive a ranging request message from the base station, and configured to transmit a ranging response message including a parameter for maintaining an idle mode, which is related to maintaining the idle mode, in response to the ranging request message to the user equipment.

A user equipment 200 includes a processor 210, a memory 220, and a RF (radio frequency) unit 230. The processor 210 implements a function, a process and/or a method proposed according to embodiment of the present invention. For instance, if a parameter for maintaining an idle mode indicates the user equipment to maintain the idle mode, the processor 210 maintains the user equipment 200 in the idle mode. The memory 220 is connected to the processor 210 and then stores various informations necessary for operating the processor 210. The RF unit 230 is connected to the processor 210 and then transmits and/or receives a radio signal under a control of the processor 210. The RF unit 230 can be configured with a plurality of nodes connected to the user equipment 200 in wired. The processor 210 may be able to control that the RF unit 230 is configured to receive a paging message from the base station, configured to transmit a ranging request message to the base station 100, and configured to receive a ranging response message including a parameter for maintaining an idle mode, which is related to maintaining the idle mode, in response to the ranging request message from the base station 100.

The processor 120/170 of the user equipment/base station 200/100 directs operations (e.g., control, adjustment, management, etc.) of an M2M device 110/base station 150. The processor 120/170 may be connected to the memory 130/180 configured to store program codes and data. The memory 130/180 is connected to the processor 120/170 to store operating systems, applications and general files.

The processor 120/170 may be called one of a controller, a microcontroller, a microprocessor, a microcomputer and the like. And, the processor 120/170 may be implemented using hardware, firmware, software and/or any combinations thereof. In case of implementing the embodiment of the present invention by hardware, the processor 120/170 may be provided with one of ASICs (application specific integrated circuits), DSPs (digital signal processors), DSPDs (digital signal processing devices), PLDs (programmable logic devices), FPGAs (field programmable gate arrays), and the like, which is configured to perform the present invention.

Meanwhile, in case of implementing the embodiments of the present invention using firmware or software, the firmware or software may be configured to include modules, procedures, and/or functions for performing the above-explained functions or operations of the present invention. And, the firmware or software configured to implement the present invention is loaded in the processor 110/210 or stored in the memory 120/220 to be driven by the processor 110/210.

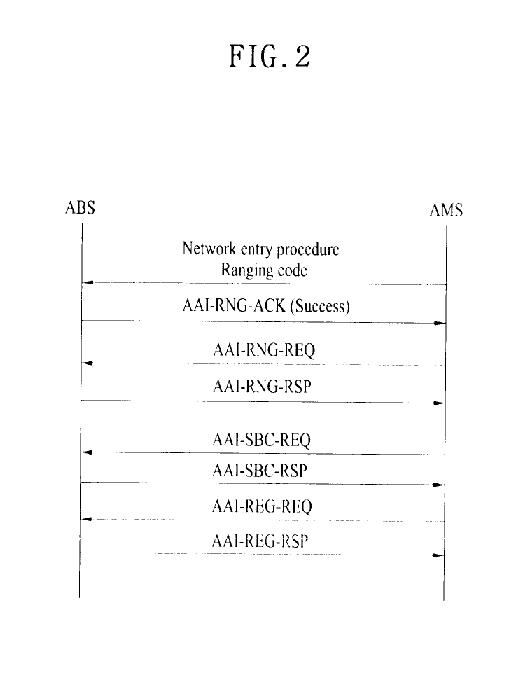

FIG. 2 is a diagram of a network entry procedure between a user equipment and a base station in a legacy IEEE 802.16m system.

Referring to FIG. 2, a user equipment transmits an initial ranging or a handover ranging to a base station (in the following description, assume that the user equipment transmits the initial ranging to the base station). The initial ranging is a process for the user equipment to obtain a precise timing offset with the base station and the process for the user equipment to adjust transmit power in an initial stage. In general, if power of the user equipment is turned on, the user equipment obtains downlink synchronization from a downlink preamble signal. And, the user equipment performs the initial ranging to adjust an uplink timing offset and the transmit power. After selecting a ranging channel, the user equipment selects a ranging preamble code from an initial ranging domain and transmits the selected ranging preamble code to the base station on the selected ranging channel.

Thereafter, the base station may be able to transmit a reception confirmation response message for the initial ranging or the handover ranging transmitted by the user equipment to the user equipment. In this case, this response message can be defined by AAI-RNG-ACK message. The AAI-RNG-ACK message is a message providing a response that ranging preamble codes are successfully received and detected on every ranging opportunity. The base station may be able to transmit the AAI-RNG-ACK message to the user equipment in a manner of including 3 available ranging statuses for the initial ranging or the handover ranging in the AAI-RNG-ACK message. In this case, the 3 available ranging statuses included in the AAI-RNG-ACK message correspond to a ‘continue’ status, a ‘success’ status, and an ‘abort’ status.

If the ranging status for the initial ranging or the handover ranging corresponds to the ‘success’ status, the base station may be able to transmit information necessary for transmitting the AAI-RNG-ACK message to the user equipment via a CDMA allocation A-MAP IE message. In particular, the base station provides the user equipment with uplink resource allocation information for a ranging request transmission and the like via the CDMA allocation A-MAP IE message. If the user equipment transmits a ranging to the base station, the base station may be able to transmit uplink resource information, which is assigned to transmit a ranging request message, to the user equipment via a resource index field and the like. If the user equipment receives the CDMA allocation A-MAP IE message from the base station, the user equipment may be able to transmit a message making a request for a ranging. Thereafter, the user equipment may be able to receive a ranging response message from the base station in response to the ranging request message.

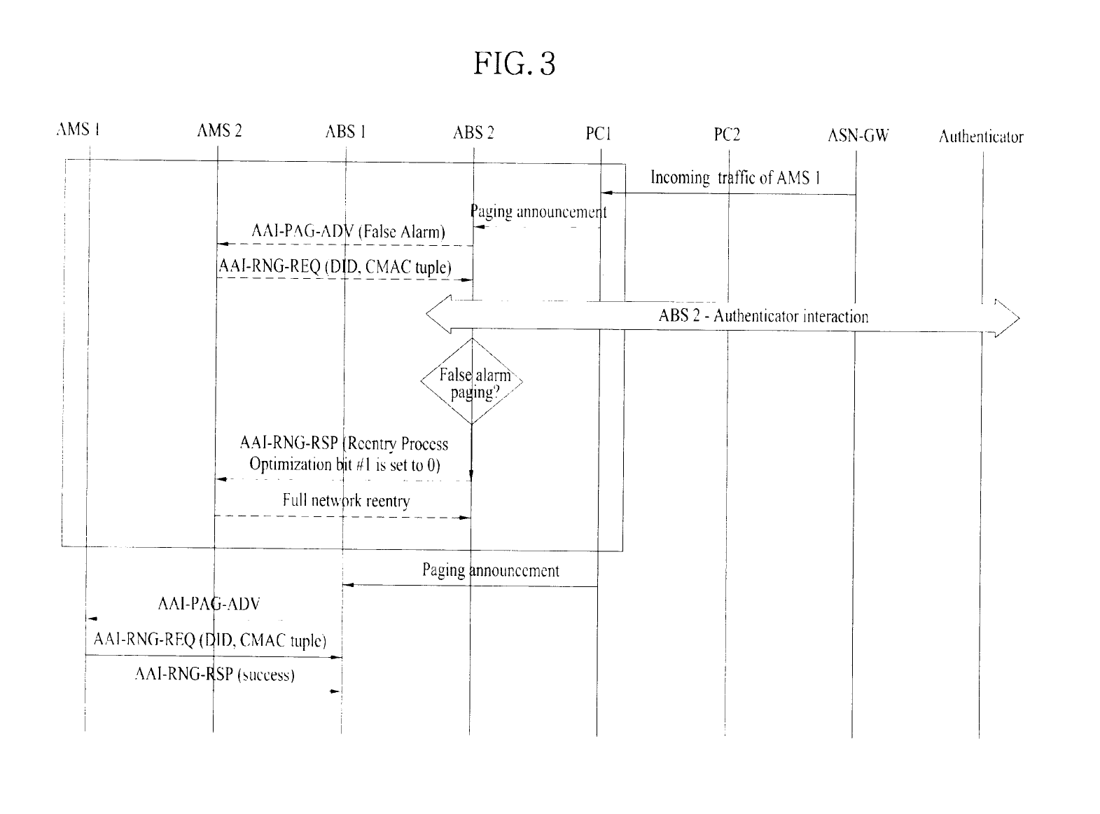

FIG. 3 is a diagram of a network entry procedure of a user equipment.

Referring to FIG. 3, in IEEE 802.16m system, each user equipment is allocated an 18-bit DID (deregistration identifier) from a network in case that the each user equipment enters an idle mode. The network identifies user equipments of idle mode via the DID (deregistration identifier) of a user equipment. And, in order to page a user equipment, a paging message includes the DID of the user equipment, which is to be paged.

Yet, as shown in FIG. 3, if a paging controller 1 and a paging controller 2 assign an identical DID, an identical paging cycle, and an identical paging offset to a 1^{st} user equipment and a 2^{nd} user equipment belonging to an identical paging group, which are currently in an idle mode, respectively, a false alarm of a paging message may occur.

As shown in FIG. 3, if ASN-GW (access service network-gateway) has traffic to be sent to the 1^{st} user equipment, the ASN-GW makes a request for a paging controller response managing the 1^{st} user equipment to a paging controller, which is situated at an ASN (access service network) region of the ASN-GW. In this case, a paging controller 1 managing the 1^{st} user equipment responds to the ASN-GW and the ASN-GW informs the paging controller 1 that the ASN-GW has traffic to be sent to the 1^{st} user equipment. The paging controller 1 transmits a paging announcement message to base stations belonging to a paging group region in a manner of including a DID of the 1^{st} user equipment. As shown in an example of FIG. 3, a 1^{st} base station and a 2^{nd} base station receive the paging announcement message from the paging controller 1 and transmit the paging message including the DID of the user equipment to the 1^{st} and the 2^{nd} user equipment.

Yet, although the paging controller 1 attempted to page the 1^{st} user equipment, the 2^{nd} user equipment receives the paging message transmitted by the 2^{nd} base station because the 2^{nd} user equipment also has a DID, a paging cycle, and a paging offset identical to that of the 1^{st} user equipment. Since this is a false alarm, the 2^{nd} user equipment performs an unnecessary network reentry. In particular, instead of staying in an idle mode in response to a paging, the 2^{nd} user equipment receives a network reentry command. The 2^{nd} user equipment transmits a ranging request (AAI-RNG-REQ) message to the 2^{nd} base station in a manner of including a DID, a paging cycle, a paging offset, a CMAC (cipher-based MAC) tuple in the ranging request message. Yet, the 2^{nd} base station exchanges a context with an authenticator to perform a CMAC verification of the 2^{nd} user equipment. It is able to know that the CMAC verification is successful based on the context received from the authenticator. Yet, if a base station notices that the paging controller 1 paged a false alarm, the base station transmits a ranging response message (AAI-RNG-RSP message) to a user equipment in a manner of configuring a reentry process optimization bit #1 of the ranging response message to ‘0’. Having received the ranging response message, the user equipment performs a full network reentry.

In particular, in the aforementioned network, although the 2^{nd} user equipment should correspond to a user equipment continuously staying in an idle mode without receiving a paging message, the 2^{nd} user equipment receives a false paging alarm message and then performs a full network reentry. This may cause an unnecessary overhead.

Hence, the present invention proposes a method of transmitting a ranging response message including a parameter for maintaining an idle state in order not to perform an unnecessary network reentry by a user equipment, which received the aforementioned false paging alarm.

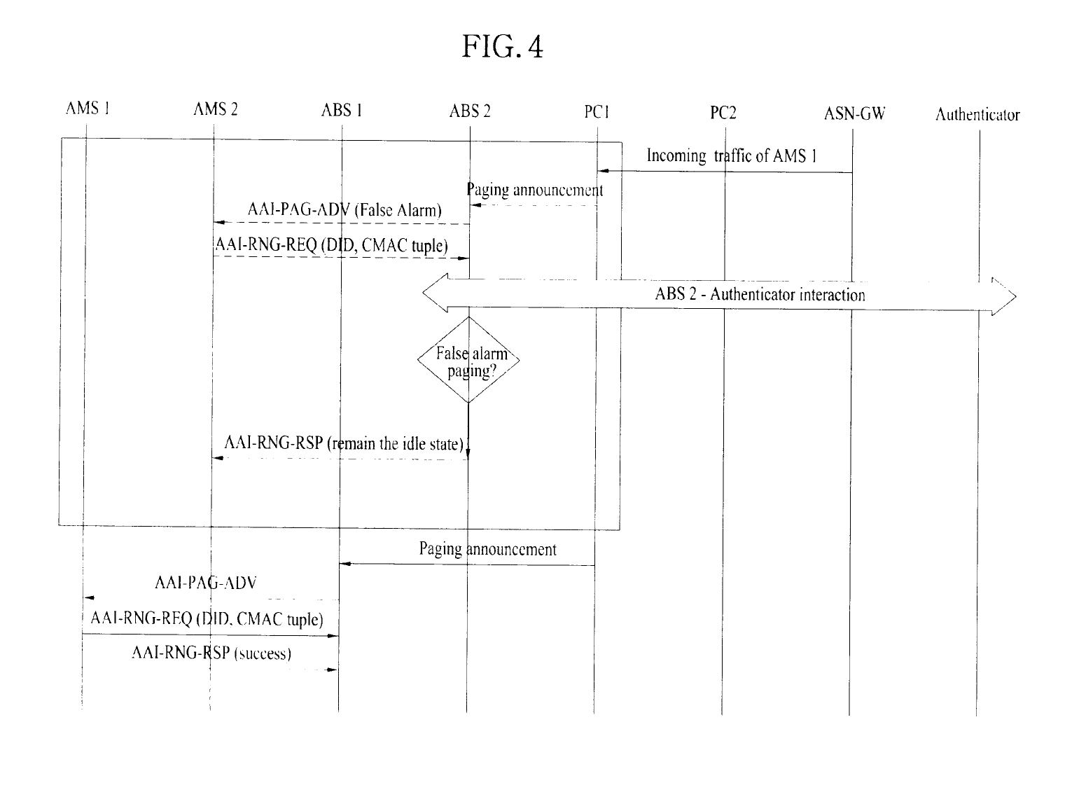

FIG. 4 is a diagram of a network entry procedure of a user equipment according to one embodiment of the present invention.

Referring to FIG. 4, if ASN-GW has traffic to be sent to the 1^{st} user equipment, the ASN-GW makes a request for a paging controller response managing the 1^{st} user equipment to a paging controller, which is situated at an ASN region of the ASN-GW. In this case, a paging controller 1 managing the 1^{st} user equipment responds to the ASN-GW and the ASN-GW notifies the paging controller 1 that there exists traffic to be sent to the 1^{st} user equipment. The paging controller 1 transmits a paging announcement message to base stations belonging to a paging group region in a manner of including a DID of the 1^{st} user equipment. As shown in FIG. 3, a 1^{st} and a 2^{nd} base station receive the paging announcement message from the paging controller 1 and transmit a paging message including DID of user equipment to the 1^{st} and the 2^{nd} user equipment.

Although the paging controller 1 attempted to page the 1^{st} user equipment, the 2^{nd} user equipment receives the paging message transmitted by the 2^{nd} base station because the 2^{nd} user equipment also has a DID, a paging cycle, and a paging offset identical to that of the 1^{st} user equipment. In this case, unlike the 2^{nd} user equipment of FIG. 3, the 2^{nd} user equipment does not perform a network reentry. In a proposed method, although a CMAC verification is successfully performed based on a context received from an authenticator, if the base station notices that the 2^{nd} user equipment was paged a false alarm from the paging controller 1, the 2^{nd} base station is able to make a request for continuously maintaining an idle mode of the 2^{nd} user equipment via a ranging response (AAI-RNG-RSP) message. By doing so, the 2^{nd} user equipment may be able to continuously maintain the idle mode without performing a full network reentry.

As shown in Table 1, a problem of the present invention can be solved in a manner of additionally including a remain idle mode parameter in the ranging response (AAI-RNG-RSP) message. The remain idle mode parameter enables a network to be efficiently operated with the small number of bit by transmitting 1 bit. The corresponding remain idle mode parameter enables a user equipment to maintain an idle mode in a manner of configuring the corresponding parameter to ‘1’ if a base station notices a fact that a user equipment transmitted a ranging request (AAI-RNG-REQ) message is not matched with a user equipment to which the paging controller paged, although a CMAC verification for the ranging request (AAI-RNG-REQ) message transmitted by the user equipment for the purpose of an idle mode reentry is successfully performed.

TABLE 1

| Attributes/ | | | |
|---|---|---|---|
| Array of | Size | | |
| attributes | (bit) | Value/Description | Conditions |
| Remain Idle | 1 | AMS shall remain | Shall be included when the |
| mode | | the idle mode | ABS decided paged AMS |
| | | | was a false alarmed AMS. |

### INDUSTRIAL APPLICABILITY

As mentioned in the foregoing description, in case that a user equipment belonging to one paging group receives a false paging message, although a method of paging to exclude a network reentry process is explained in a manner of centering on an example applied to IEEE 802.16m system, the method can be applied to various wireless communication systems as well as IEEE 802.16m system.

What is claimed is:

1. A method for receiving information of remaining idle mode, which is received by a user equipment in a wireless communication system, comprising the steps of:
receiving a paging message from a base station;
transmitting a ranging request message to the base station; and
receiving a ranging response message containing a remain idle mode parameter related to remaining the idle mode of the UE from the base station in response to the ranging request message.

2. The method of claim 1, if the remain idle mode parameter indicates the UE to remain the idle mode, further comprising the step of remaining the idle mode as it is by the UE.

3. The method of claim 1, wherein the ranging request message comprises a Deregistration Identifier (DID) assigned to the UE.

4. The method of claim 1, wherein the paging message corresponds to a false alarmed message of the base station.

5. A method for transmitting information of remaining idle mode, which is transmitted by a base station in a wireless communication system, comprising the steps of:
transmitting a paging message to a User Equipment (UE);
receiving a ranging request message from the UE;
obtaining information on whether the paging message is a false alarm message from an authenticator; and
transmitting a ranging response message containing a remain idle mode parameter related to remaining the idle mode to the UE.

6. The method of claim 5, wherein the remain idle mode parameter corresponds to an indicator remaining the idle mode of the UE.

7. The method of claim 5, wherein the ranging request message comprises a DID (Deregistration Identifier) assigned to the UE.

8. A User Equipment (UE) configured to receive information of remaining idle mode in a wireless communication system, comprising:
a Radio Frequency (RF) unit configured to transmit and receive wireless signals; and
a processor configured to control the RF unit in a manner of being connected to the RF unit,
wherein the processor is configured to control the RF unit to receive a paging message from a base station, to transmit a ranging request message to the base station, and to receive a ranging response message containing a remain idle mode parameter related to remaining the idle mode of the UE from the base station in response to the ranging request message.

9. The UE of claim 8, wherein if the remain idle mode parameter indicates the UE to remain the idle mode, the processor is configured to remain the idle mode of the UE.

10. The UE of claim 8, wherein the ranging request message comprises a DID (Deregistration Identifier) assigned to the UE.

11. The UE of claim 8, wherein the paging message corresponds to a false alarmed message of the base station.

12. A base station configured to transmit information of remaining idle mode in a wireless communication system, comprising:
a Radio Frequency (RF) unit configured to transmit and receive wireless signals; and
a processor configured to control the RF unit in a manner of being connected to the RF unit,
wherein the processor is configured to control the RF unit to transmit a paging message to a UE (User Equipment), configured to control the RF unit to receive a ranging request message from the UE, configured to obtain information on whether the paging message is a false alarm message from an authenticator, and configured to control the RF unit to transmit a ranging response message containing a remain idle mode parameter related to remaining the idle mode to the UE.

13. The base station of claim 12, wherein the processor is configured to control the RF unit to transmit the remain idle mode parameter indicating the remaining idle mode of the UE to the UE.

14. The base station of claim 12, wherein the ranging request message comprises a DID (Deregistration Identifier) assigned to the UE.
